(19) United States
(12) Patent Application Publication
(10) Pub. No.: US 2021/0300141 A1
(43) Pub. Date: Sep. 30, 2021

(54) ANTI-ROLL BAR ASSEMBLY FOR A VEHICLE AND VEHICLE HAVING SAME

(71) Applicant: BOMBARDIER RECREATIONAL PRODUCTS INC., Valcourt (CA)

(72) Inventors: Christian DE GRAMMONT, Sherbrooke (CA); Sebastien HEBERT, Sherbrooke (CA); Alexandre HEBERT-THIBAULT, Sherbrooke (CA); Charles DESPRES-NADEAU, Sherbrooke (CA)

(21) Appl. No.: 17/218,702

(22) Filed: Mar. 31, 2021

Related U.S. Application Data
(60) Provisional application No. 63/002,891, filed on Mar. 31, 2020.

(51) Int. Cl. B60G 21/02

(52) U.S. Cl. CPC B60G 21/026; B60G 2202/135; B60G 2300/124; B60G 2204/1224; B60G 2206/427; B60G 2206/821; B60G 2204/1222

(57) ABSTRACT

A vehicle has left and right suspension arms operatively connecting left and right ground-engaging members to the vehicle's frame. An anti-roll bar assembly operatively connects the left and right suspension arms. The anti-roll bar assembly includes: an anti-roll bar having left and right end portions operatively connected to the left and right suspension arms, and at least one anti-roll bar connection assembly connecting a middle portion of the anti-roll bar to the frame. Each of the at least one anti-roll bar connection assembly includes: an elastomeric insert mounted to the anti-roll bar, the elastomeric insert engaging the anti-roll bar such that an inner surface of the elastomeric insert rotates together with the anti-roll bar; and a mounting bracket connected to the frame and at least partly enclosing the elastomeric insert, an outer surface of the elastomeric insert being rotatably fixed relative to the mounting bracket.

### CROSS-REFERENCE

The present application claims priority from U.S. Provisional Patent Application No. 63/002,891, filed on Mar. 31, 2020, the entirety of which is incorporated by reference herein.

### FIELD OF THE TECHNOLOGY

The present technology relates to anti-roll bar assemblies for vehicles.

### BACKGROUND

Some vehicles, including for example all-terrain vehicles (ATVs) and similar vehicles, are often equipped with anti-roll bar assemblies (sometimes referred to as “sway bar assemblies”) to provide stability thereto such as when cornering or travelling over uneven terrain. A conventional anti-roll bar assembly typically includes an anti-roll bar supported by bushings enclosed within respective metallic housings that are connected to the vehicle's frame.

During use, the bushings of such conventional anti-roll bar assemblies are subjected to wear and therefore a certain amount of play between the bushings and the anti-roll bar can be expected after some use. Notably, the bushings are typically subject to regular greasing performed during maintenance which leads to the intrusion of dirt into the bushings which exacerbates the wear thereof When the bushings become excessively worn, the play between the bushings and the anti-roll bar may become significant and relative motion between the anti-roll bar and the bushings may generate noise, particularly when the vehicle is travelling over uneven terrain. This can be remedied by replacing the worn bushings with new replacement bushings. However, since the anti-roll bar assembly generally fulfils its function irrespective of the wear on the bushings, drivers often forego replacing the bushings and continue operating their vehicles despite the excessive noise being generated.

In addition, connecting left and right suspension arms of an ATV to the anti-roll bar assembly typically requires handling of various parts at the same time which can be difficult when done alone. Notably, a user has to align the suspension arms with the anti-roll bar assembly and fasten the anti-roll bar assembly to the suspension arms.

Thus, there is a desire for an anti-roll bar assembly for a vehicle that addresses some of the aforementioned drawbacks.

### SUMMARY

It is an object of the present technology to ameliorate at least some of the inconveniences present in the prior art.

According to an aspect of the present technology, there is provided a vehicle. The vehicle includes: a frame; a seat supported by the frame; a motor supported by the frame; a plurality of ground-engaging members operatively connected to the frame, at least one ground-engaging member of the plurality of ground-engaging members being operatively connected to the motor for propelling the vehicle, the plurality of ground-engaging members including a left ground-engaging member disposed on a left side of a longitudinal centerplane of the vehicle and a right ground-engaging member disposed on a right side of the longitudinal centerplane of the vehicle; a left suspension arm operatively connecting the left ground-engaging member to the frame; a right suspension arm operatively connecting the right ground-engaging member to the frame; and an anti-roll bar assembly operatively connecting the left suspension arm to the right suspension arm. The anti-roll bar assembly includes: an anti-roll bar having a left end portion, a right end portion and a middle portion extending between the left and right end portions, the left end portion being operatively connected to the left suspension arm, the right end portion being operatively connected to the right suspension arm; and at least one anti-roll bar connection assembly connecting the middle portion of the anti-roll bar to the frame. Each of the at least one anti-roll bar connection assembly includes: an elastomeric insert mounted to the anti-roll bar, the elastomeric insert engaging the anti-roll bar such that an inner surface of the elastomeric insert rotates together with the anti-roll bar; and a mounting bracket connected to the frame and at least partly enclosing the elastomeric insert, an outer surface of the elastomeric insert being rotatably fixed relative to the mounting bracket.

In some embodiments, the outer surface of the elastomeric insert has a shape that is congruous with a shape of an inner side of the mounting bracket to prevent rotation of the elastomeric insert relative to the mounting bracket.

In some embodiments, the outer surface of the elastomeric insert has at least one flat side.

In some embodiments, the outer surface of the elastomeric insert has a polygonal cross-section.

In some embodiments, the outer surface of the elastomeric insert has a trapezoidal cross-section.

In some embodiments, the elastomeric insert is bonded to the mounting bracket to prevent rotation of the outer surface of the elastomeric insert relative to the mounting bracket.

In some embodiments, the elastomeric insert is made of rubber.

In some embodiments, the left and right end portions of the anti-roll bar are rotatable about an anti-roll bar axis extending generally laterally between a maximum upper position and a maximum lower position; and the inner surface of the elastomeric insert is fixed to the anti-roll bar in a resting position of the left and right end portions defined between the maximum upper position and the maximum lower position so that the left and right end portions of the anti-roll bar are biased toward the resting position.

In some embodiments, the resting position of the left and right end portions of the anti-roll bar corresponds to a position of the anti-roll bar assembly and the left and right suspension arms when the vehicle is stationary on a flat ground surface.

In some embodiments, the inner surface of the elastomeric insert is bonded to the anti-roll bar.

In some embodiments, the at least one anti-roll bar connection assembly includes a first anti-roll bar connection assembly and a second anti-roll bar connection assembly.

In some embodiments, the elastomeric insert is formed on the anti-roll bar so that the inner surface of the elastomeric insert is bonded to the anti-roll bar.

In some embodiments, the anti-roll bar assembly also includes: a left link operatively connected between the left end portion of the anti-roll bar and the left suspension arm; and a right link operatively connected between the right end portion of the anti-roll bar and the right suspension arm.

In some embodiments, the vehicle is an all-terrain vehicle (ATV).

According to another aspect of the present technology, there is provided an anti-roll bar assembly for a vehicle. The anti-roll bar assembly includes: an anti-roll bar having a left end portion, a right end portion and a middle portion extending between the left and right end portions, the left end portion being configured to be operatively connected to a left suspension arm of the vehicle, the right end portion being configured to be operatively connected to a right suspension arm of the vehicle; and at least one anti-roll bar connection assembly configured to connect the middle portion of the anti-roll bar to a frame of the vehicle. Each of the at least one anti-roll bar connection assembly includes: an elastomeric insert mounted to the anti-roll bar, the elastomeric insert engaging the anti-roll bar such that an inner surface of the elastomeric insert rotates together with the anti-roll bar; and a mounting bracket configured to be connected to the frame of the vehicle and at least partly enclosing the elastomeric insert, an outer surface of the elastomeric insert being rotatably fixed relative to the mounting bracket.

In some embodiments, the outer surface of the elastomeric insert has a shape that is congruous with a shape of an inner side of the mounting bracket to prevent rotation of the elastomeric insert relative to the mounting bracket.

In some embodiments, the outer surface of the elastomeric insert has at least one flat side.

In some embodiments, the outer surface of the elastomeric insert has a polygonal cross-section.

In some embodiments, the outer surface of the elastomeric insert has a trapezoidal cross-section.

In some embodiments, the elastomeric insert is bonded to the mounting bracket to prevent rotation of the outer surface of the elastomeric insert relative to the mounting bracket.

In some embodiments, the elastomeric insert is made of rubber.

In some embodiments, the at least one anti-roll bar connection assembly includes a first anti-roll bar connection assembly and a second anti-roll bar connection assembly.

In some embodiments, the inner surface of the elastomeric insert is bonded to the anti-roll bar.

In some embodiments, the elastomeric insert is formed on the anti-roll bar so that the inner surface of the elastomeric insert is bonded to the anti-roll bar.

In some embodiments, the anti-roll bar assembly also includes: a left link operatively connected to the left end portion of the anti-roll bar and configured to be operatively connected to the left suspension arm; and a right link operatively connected to the right end portion of the anti-roll bar and configured to be operatively connected to the right suspension arm.

For purposes of the present application, terms related to spatial orientation when referring to a vehicle and components in relation to the vehicle, such as “forwardly”, “rearwardly”, “left”, “right”, “above” and “below”, are as they would be understood by a driver of the vehicle sitting thereon in an upright driving position, with the vehicle steered straight-ahead.

Embodiments of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of embodiments of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a left side elevation view of an all-terrain vehicle (ATV);

FIG. 2 is a perspective view, taken from a rear right side, of two rear suspension arms and an anti-roll bar assembly of the ATV of FIG. 1 according to an embodiment of the present technology;

FIG. 3 is a perspective view, taken from a rear right side, of an anti-roll bar and two anti-roll bar connection assemblies of the anti-roll bar assembly of FIG. 2;

FIG. 4 is a perspective view, taken from a rear right side, of the anti-roll bar and anti-roll bar connection assemblies of FIG. 3, with one of the anti-roll bar connection assemblies shown in an exploded configuration;

FIG. 5 is a cross-sectional view of the anti-roll bar and anti-roll bar connection assemblies taken along line 5-5 in FIG. 3;

FIG. 6 is a perspective view, taken from a rear right side, of the anti-roll bar and the anti-roll bar connection assemblies according to another embodiment of the present technology;

FIG. 7 is a cross-sectional view of the anti-roll bar and anti-roll bar connection assemblies of FIG. 6 taken along line 7-7 in FIG. 6;

FIG. 8 is a perspective view, taken from a rear right side, of the anti-roll bar and the anti-roll bar connection assemblies according to another embodiment of the present technology;

FIG. 9 is a perspective view, taken from a rear right side, of the anti-roll bar and anti-roll bar connection assemblies of FIG. 8, with one of the anti-roll bar connection assemblies shown in an exploded configuration;

FIG. 10 is a cross-sectional view of the anti-roll bar and anti-roll bar connection assemblies of FIG. 8 taken along line 10-10 in FIG. 8;

FIG. 11 is a right side elevation view of a right suspension arm and the anti-roll bar assembly of FIG. 8, with the right suspension arm shown in a fully compressed position;

FIG. 12 is a right side elevation view of the right suspension arm and the anti-roll bar assembly of FIG. 8, with the right suspension arm shown in a fully extended position;

FIG. 13 is a right side elevation view of the right suspension arm and the anti-roll bar assembly of FIG. 8, with the right suspension arm shown in a position corresponding to the ATV being stationary on a flat ground surface and unloaded;

FIG. 14 is a cross-sectional view of the anti-roll bar and the anti-roll bar connection assemblies of FIG. 8 taken along a line extending through a left one of the anti-roll bar connection assemblies, with a left end portion of the anti-roll bar shown in a maximum upper position;

FIG. 15 is a cross-sectional view of the anti-roll bar and the anti-roll bar connection assemblies of FIG. 8 taken along a line extending through a left one of the anti-roll bar connection assemblies, with the left end portion of the anti-roll bar shown in a maximum lower position;

FIG. 16 is a cross-sectional view of the anti-roll bar and the anti-roll bar connection assemblies of FIG. 8 taken along a line extending through a left one of the anti-roll bar connection assemblies, with the left end portion of the anti-roll bar shown in a resting position; and

FIG. 17 is a cross-sectional view of the anti-roll bar and the anti-roll bar connection assemblies according to another embodiment of the present technology, taken along a line extending through a left one of the anti-roll bar connection assemblies, with a left end portion of the anti-roll bar shown in the maximum lower position.

### DETAILED DESCRIPTION

The present technology will be described with reference to a four-wheeled straddle-seat all-terrain vehicle (ATV) 10. However, it is contemplated that aspects of the present technology could be used in other types of vehicles including other off-road vehicles, such as side-by-side vehicles, dune buggies, snowmobiles and the like.

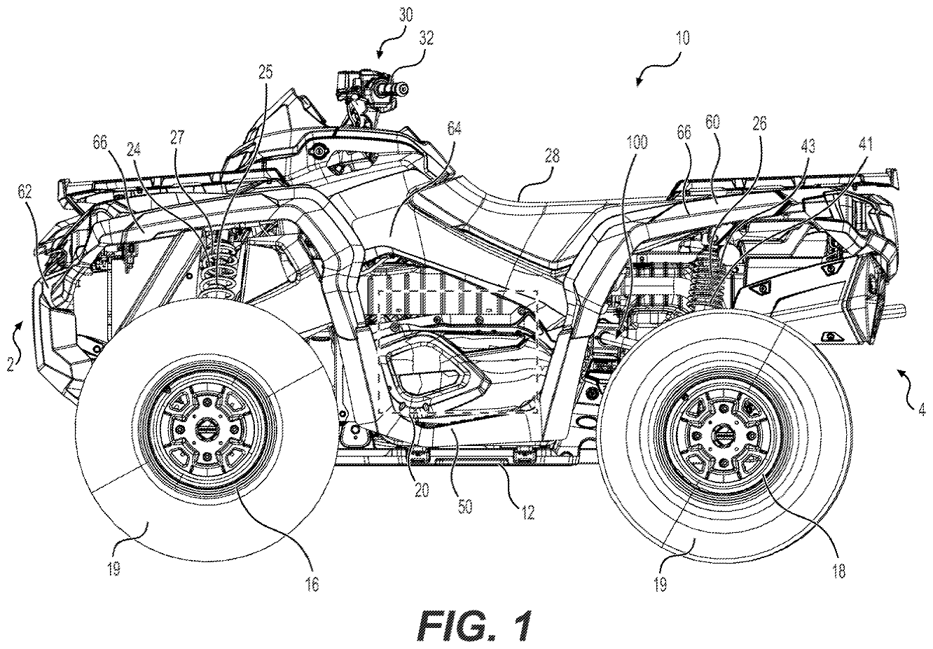

With reference to FIG. 1, the ATV 10 has a front end 2 and a rear end 4 defined consistently with a forward travel direction of the ATV 10. The ATV 10 has a frame 12 to which a vehicle body is mounted. A pair of front ground-engaging wheels 16 is suspended from a front portion of the frame 12 via front suspension assemblies 24. A pair of rear ground-engaging wheels 18 is suspended from a middle portion of the frame 12 via left and right rear suspension assemblies 26. The front and rear wheels 16, 18 are provided with tires 19 adapted for off-road conditions and traversing rugged terrain. Other ground-engaging members are also contemplated. For instance, in some embodiments, the front and rear wheels 16, 18 could be replaced by front and rear track assemblies including endless drive tracks.

As shown in FIG. 1, the ATV 10 also includes fairings 60 including a front fascia 62 at the front end 2 of the ATV 10 and several side panels 64 extending over lateral sides of the ATV 10. A fender 66 is disposed over each wheel well overarching the wheels 16, 18 to protect the driver and/or passenger from dirt, water and other debris being projected by the wheels 16, 18. The ATV 10 also has a straddle-type driver seat 28 mounted to and supported by the frame 12 for accommodating a driver of the ATV 10. Driver footrests 50 are provided on either side of the driver seat 28 and are disposed vertically lower than the driver seat 28 to support the driver's feet. Another straddle-type passenger seat may be provided behind the driver seat 28 to accommodate a passenger.

In this embodiment, each front suspension assembly 24 is a double A-arm suspension assembly and includes an upper A-arm (not shown), a lower A-arm (not shown), a front shock absorber 25 and a front coil spring 27. The front coil spring 27 is mounted over the front shock absorber 25. The front coil spring 27 and the front shock absorber 25 are both pivotably connected at their lower ends to the upper A-arm and at their upper ends to the frame 12. The upper and lower A-arms each have one end pivotably connected to the frame 12 while a steering knuckle is mounted to the opposite ends of the upper and lower A-arms. A drive hub assembly is mounted to the steering knuckle for connecting a corresponding one of the front wheels 16 thereto.

In other embodiments, the front suspension assemblies 24 could be MacPherson strut suspension assemblies.

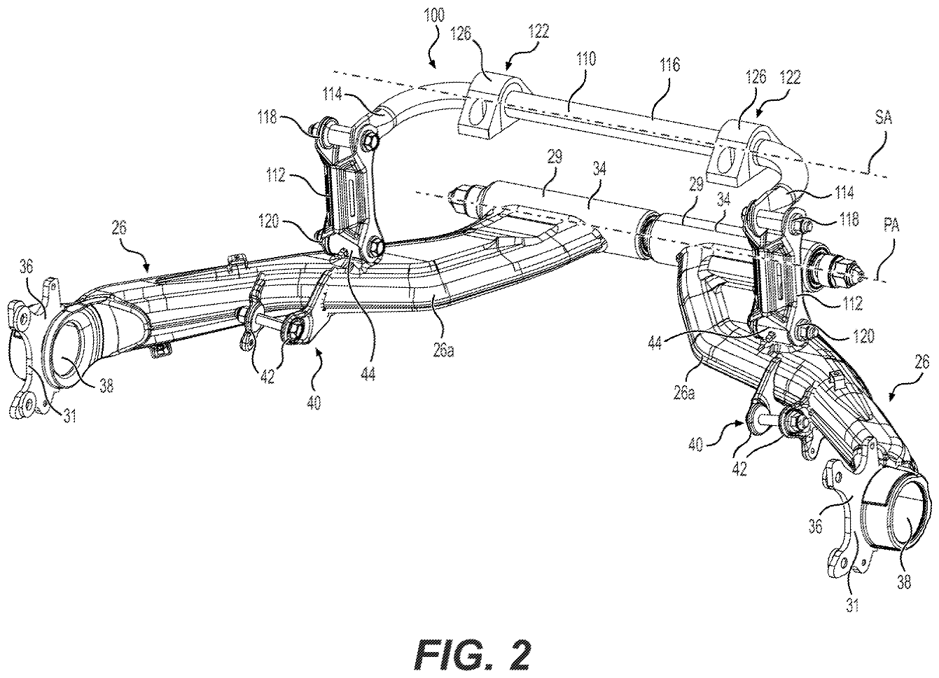

With reference to FIG. 2, in this embodiment, each of the left and right rear suspension assemblies 26 includes a respective suspension arm 26a operatively connecting a corresponding one of the left and right rear wheels 18 to the frame 12.

The left and right suspension arms 26a are pivotably connected to the frame 12 about a pivot axis PA extending generally laterally. As such, the suspension arms 26a swing about the pivot axis PA as the rear wheels 18 encounter uneven terrain when the ATV 10 is being driven. In this embodiment, the left and right suspension arms 26a are mirror images of one another about a longitudinal centerplane of the ATV 10.

Therefore, only the left suspension arm 26a will be described in detail below. It is to be understood that the same description applies to the right suspension arm 26a in a mirrored arrangement about the longitudinal centerplane of the ATV 10.

The left suspension arm 26a extends from a front end 29 to a rear end 31. The left suspension arm 26a has a pivoting mount 34 provided at the front end 29 which receives a shaft (not shown) of the frame 12 defining the pivot axis PA. At the rear end 31, the left suspension arm 26a has a wheel mount 36 to which the left rear wheel 18 is operatively mounted. The wheel mount 36 defines a hub 38 through which a half shaft (not shown) of the ATV 10 extends for connection to the left rear wheel 18. The front end 29 of the left suspension arm 26a is disposed laterally inwardly of the rear end 31. Notably, the left suspension arm 26a extends rearwardly and laterally outwardly (i.e., leftwardly) from the front end 29 to the rear end 31. The left suspension arm 26a also includes a shock absorber mount 40 for mounting a shock absorber 41 (partially shown in FIG. 1). A coil spring 43 is mounted over the shock absorber 41. The coil spring 43 and the shock absorber 41 are both pivotably connected at their lower ends to the left suspension arm 26a and at their upper ends to the frame 12. The shock absorber mount 40 includes two flanges 42 extending parallel to one another. The two flanges 42 of the shock absorber mount 40 extend rearwardly on a right side of the left suspension arm 26a.

It is contemplated that, in other embodiments, the rear suspension assemblies 26 may be configured differently. For instance, in some embodiments, each rear suspension assembly 26 could have a double A-arm configuration, such as that described with reference to the front suspension assemblies 24. As such, the left and right suspension arms 26a could be upper or lower A-arms. In yet other embodiments, the rear suspension assembly 26 could have a semi trailing-arm configuration or a multi-link configuration.

As will be explained in detail below, an anti-roll bar assembly 100 according to an embodiment of the present technology is connected between the left and right suspension arms 26a.

A steering assembly 30 is rotationally supported by the frame 12 to enable a driver to steer the ATV 10. The steering assembly 30 includes a handlebar assembly including a handlebar 32 connected to a steering column (not shown) for actuating steering linkages (not shown) operatively connected to the left and right front wheels 16. In this embodiment, the steering assembly 30 includes a power steering electric motor mounted to the steering column for facilitating steering. The power steering electric motor is operatively connected to the steering column and to the left and right front wheels 16 via the steering linkages. The power steering electric motor could be omitted in other embodiments.

As shown in FIG. 1, a throttle operator (not shown) in the form of a thumb-actuated throttle lever is provided near the right end of the handlebar 32. Other types of throttle operators, such as a finger-actuated throttle lever and a twist grip, are also contemplated. For instance, the throttle operator could be cable actuated in some embodiments. The throttle operator is selectively actuated by the driver of the ATV 10 to request throttle from the engine. More specifically, a throttle operator position sensor (not shown) is operatively connected to the throttle operator to sense movement thereof caused by the driver in operation. The sensed input from the throttle operator position sensor is transmitted to an electronic control unit (ECU) (not shown) which controls operation of the ATV's motor 20.

The motor 20 (schematically shown in FIG. 1) is mounted to the middle portion of the frame 12 and is operatively connected to the front and rear wheels 16, 18 in order to propel the ATV 10. In this embodiment, the motor 20 is an internal combustion engine, and in particular a V-type engine having two cylinders. The cylinders are disposed at an angle to each other. Each cylinder has an intake port (not shown) connected to an air induction system delivering air into the engine 20. Each cylinder has a fuel injector injecting fuel into the engine 20 and a spark plug igniting the fuel-air mixture to initiate the combustion cycle. Each cylinder has an exhaust port connected to an exhaust manifold through which the exhaust gases are removed from the engine 20. It is contemplated that other types of internal combustion engine could be used, such as, for example, an inline engine. It is also contemplated that the engine 20 could have a different number of cylinders, such as a single cylinder or more than two cylinders.

It is contemplated that the engine 20 could instead be a different type of motor in other embodiments. For example, in some embodiments, the engine 20 could instead be an electric motor, in which case the engine air induction or air exhaust systems may be omitted.

The ATV 10 has many other components, the function and configuration of which are known to a person skilled in the art. These components will therefore not be described in detail herein.

Furthermore, it is contemplated that the ATV 10 could be configured differently in other embodiments. The illustrated construction of the ATV 10 is thus not considered to be limiting to the present technology.

As mentioned above, the anti-roll bar assembly 100 is provided to operatively connect the left and right rear suspension arms 26a, thereby helping reduce the body roil of the ATV 10 during fast cornering or over uneven terrain. In particular, the anti-roll bar assembly 100 increases the roll stiffness associated with the rear suspension assemblies 26.

With reference to FIG. 2, the anti-roll bar assembly 100 includes an anti-roll bar 110 and left and right links 112 operatively connecting the anti-roll bar 110 to the left and right rear suspension arms 26a respectively. The anti-roll bar 110 is configured to counter the upward movement of one of the left and right rear suspension arms 26a relative to the other. In that sense, the anti-roll bar 110 acts as a torsion spring connected between the suspension arms 26a.

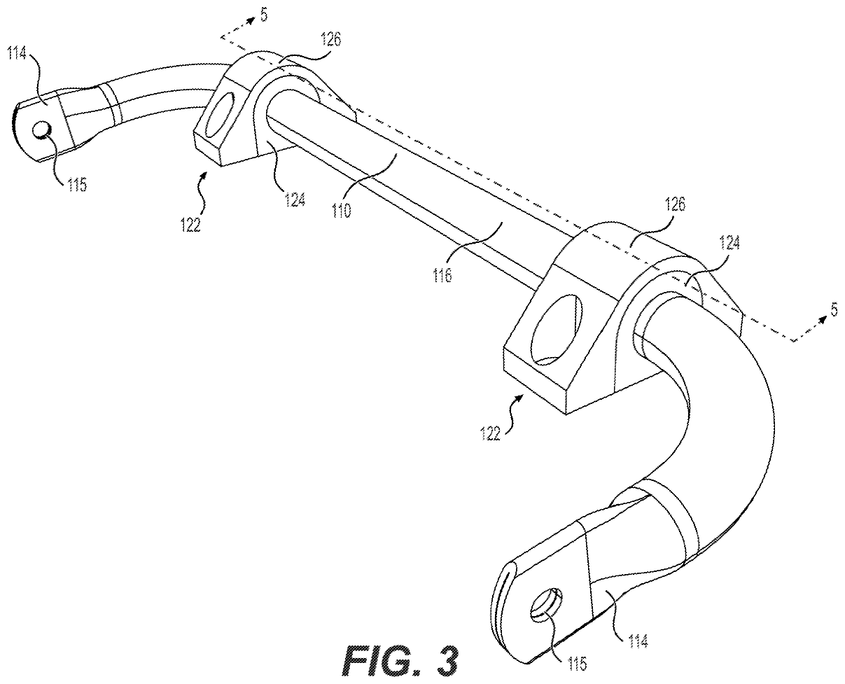

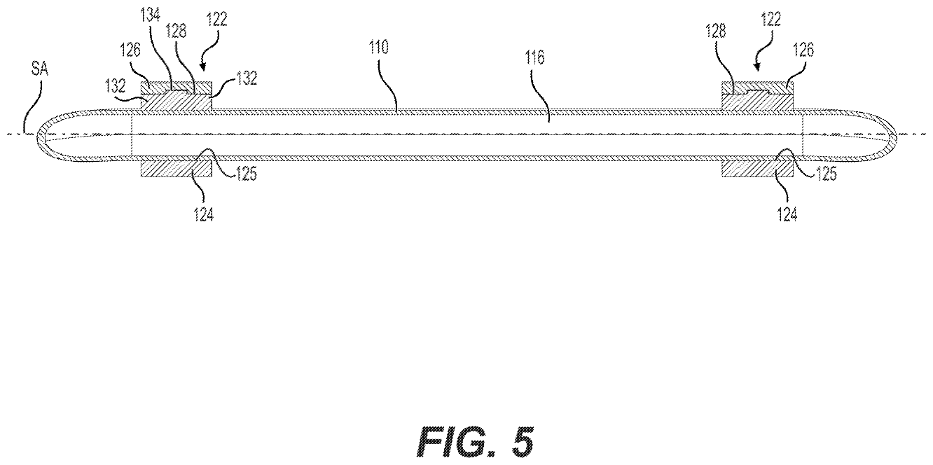

The anti-roll bar 110 has left and right end portions 114 and a middle portion 116 extending between the left and right end portions 114. As can be seen, when the anti-roll bar 110 is mounted between the suspension arms 26a, the middle portion 116 extends generally laterally (i.e., parallel to the pivot axis PA). The middle portion 116 is tubular, having an annular cross-section. Notably, as shown in FIG. 5, the middle portion 116 of the anti-roll bar 110 is hollow. It is contemplated that the middle portion 116 could be solid in other embodiments. The left end portion 114 and the right end portion 114 are respectively operatively connected to the left and right rear suspension arms 26a via the left and right links 112. The left and right end portions 114 extend generally perpendicular to the middle portion 116. The end portions 114 curved into the middle portion 116. As can be seen in FIG. 3, each of the left and right end portions 114 defines an aperture 115 for connection to the corresponding link 112.

The anti-roll bar 110 can be configured differently in accordance with different implementations.

With reference to FIG. 2, each of the left and right links 112 is connected between a corresponding one of the left and right end portions 114 of the anti-roll bar 110 and a corresponding one of left and right link mounts 44 of the rear left and right suspension arms 26a. Notably, an upper end 118 of each of the links 112 is pivotably connected to the corresponding end portion 114 of the anti-roll bar 110 while a lower end 120 of each of the links 112 is pivotably connected to the corresponding link mount 44. In this embodiment, each of the link mounts 44 of the suspension arms 26a comprises a bushing defining an opening for receiving therein a fastener extending through the lower end 120 of the corresponding link 112. The lower end 120 of each link 112 has two flanges between which the corresponding link mount 44 can be inserted for connection therewith. Two spacers are disposed between the flanges of the lower end 120 and the link mount 44. A grease zerk is disposed on an outer side of the link mount 44 to allow lubrication of the bushing thereof. The grease zerk could be omitted. Similarly, the upper end 118 of each link 112 has two flanges between which part of the corresponding end portion 114 can be inserted for connection therewith. In particular, the opening 115 defined by each end portion 114 receives a fastener that extends through the end portion 114 and the upper end 118 of the link 112.

The anti-roll bar assembly 100 also includes two anti-roll bar connection assemblies 122 connecting the middle portion 116 of the anti-roll bar 110 to the frame 12 of the ATV 10. The two anti-roll bar connection assemblies 122 include a left anti-roll bar connection assembly 122 and a right anti-roll bar connection assembly 122 that are laterally spaced from one another. With reference to FIG. 2, the anti-roll bar 110 is pivotable about an anti-roll bar axis SA defined by the anti-roll bar connection assemblies 122. The anti-roll bar axis SA extends generally laterally (i.e., parallel to the pivot axis PA). In this embodiment, both the anti-roll bar connection assemblies 122 are identical to one another. Therefore, a single one of the anti-roll bar connection assemblies 122 will be described below. It is to be understood that the same description applies to both anti-roll bar connection assemblies 122.

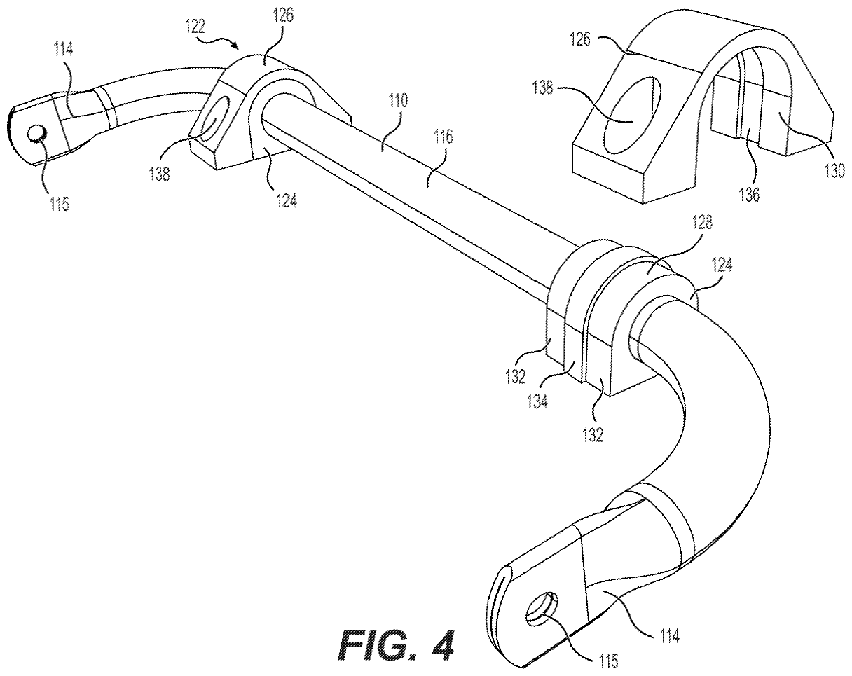

The anti-roll bar connection assembly 122 in accordance with the present embodiment will be described with reference to FIGS. 3 to 5. As can be seen, the anti-roll bar connection assembly 122 includes an elastomeric insert 124 mounted to the anti-roll bar 110 and a mounting bracket 126 connected to the frame 12. As can be seen in FIG. 4, the elastomeric insert 124 is enclosed in part by the mounting bracket 126.

The elastomeric insert 124 surrounds a section of the anti-roll bar 110 such that an inner surface 125 of the elastomeric insert 124 is in contact with the outer surface of the anti-roll bar 110. In particular, the elastomeric insert 124 engages the middle portion 116 of the anti-roll bar 110 such that the inner surface 125 (FIG. 5) of the elastomeric insert 124 rotates together with the anti-roll bar 110 during operation thereof (i.e., no relative movement between the inner surface 125 and the outer surface of the middle portion 116 of the anti-roll bar 110). To that end, in this embodiment, the elastomeric insert 124 is formed on the anti-roll bar 110 during manufacturing thereof (e.g., by injection molding) such that the inner surface 125 of the elastomeric insert 124 is bonded to the anti-roll bar 110. It is contemplated that the inner surface 125 of the elastomeric insert 124 could be otherwise made to rotate together with the anti-roll bar 110. For instance, in alternative embodiments, the cross-section of the anti-roll bar 110 may be non-circular (e.g., square or hexagonal) and the inner surface 125 of the elastomeric insert 124 could have a matching non-circular shape such that the inner surface of the elastomeric insert 124 rotates together with the anti-roll bar 110.

Ensuring that the inner surface 125 rotates together with the anti-roll bar 110 prevents any space from forming between the elastomeric insert 124 and the anti-roll bar 110. This averts debris from being lodged between the anti-roll bar 110 and the elastomeric insert 124 which would further cause wear of the elastomeric insert 124 if the inner surface 125 of the elastomeric insert 124 were to rotate relative to the anti-roll bar 110.

An outer surface 128 of the elastomeric insert 124 is rotatably fixed relative to the mounting bracket 126. In particular, in this embodiment, the outer surface 128 of the elastomeric insert 124 has a shape that is congruous with a shape of an inner side 130 of the mounting bracket 126 so as to prevent rotation of the elastomeric insert 124 relative to the mounting bracket 126. For instance, in this embodiment, the outer surface 128 has a cross-section, taken along a plane normal to the anti-roll bar axis SA, that has a semi-stadium shape defined by a semi-circular end and an opposite rectangular end. As such, the outer surface 128 has two flat sides, opposite one another, that are in contact with corresponding flat surfaces of the inner side 130 of the mounting bracket 126.

Rotatably fixing the inner surface 125 and the outer surface 128 of the elastomeric insert 124 with the anti-roll bar 110 and the mounting bracket 126 respectively reduces the amount of noise that would otherwise be generated if these interfaces were not rotatably fixed, as is typically the case in conventional anti-roll bar assemblies.

In this embodiment, as shown in FIG. 4, the outer surface 128 of the elastomeric insert 124 has two reduced sections 132 and an enlarged section 134 disposed laterally between the two reduced sections 132. Each of the reduced sections 132 and the enlarged section 134 have a corresponding outer surface (which is a portion of the outer surface 128) having a cross-section with the same semi-stadium shape. However, the outer surface defined by the enlarged section 134 has greater dimensions than the outer surface of each of the reduced sections 132. For instance, as shown in FIG. 5, the outer surface of the enlarged section 134 extends further from the anti-roll bar axis SA than the outer surface of the reduced sections 132.

In this embodiment, the elastomeric insert 124 is made of rubber. Nevertheless, it is contemplated that the elastomeric insert 124 could be made of any other suitable elastomeric material in other embodiments.

The mounting bracket 126 is a rigid housing that encloses the elastomeric insert 124. Notably, as mentioned above, in this embodiment, the inner side 130 of the mounting bracket 126 has a shape congruous to the outer surface 128 of the elastomeric insert 124. In particular, as shown in FIG. 4, the inner side 130 of the mounting bracket 126 defines a recess 136 defined that receives the enlarged section 134 of the elastomeric insert 124 therein. The mounting bracket 126 also defines two exterior recesses 138 (one of which is shown in FIG. 4). At the bottom of each recess 138, the mounting bracket 126 defines an aperture (not shown) for insertion of a fastener to engage a portion of the frame 12 of the ATV 10 so as to affix the mounting bracket 126 to the frame 12.

In this embodiment, the mounting bracket 126 is made of metallic material. It is contemplated that the mounting bracket 126 could be made of any other suitable material in other embodiments.

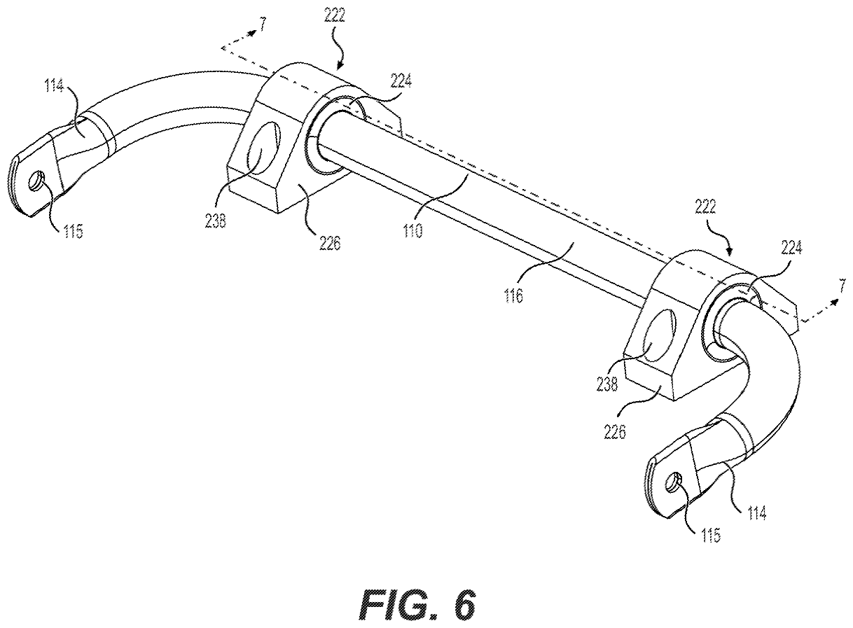

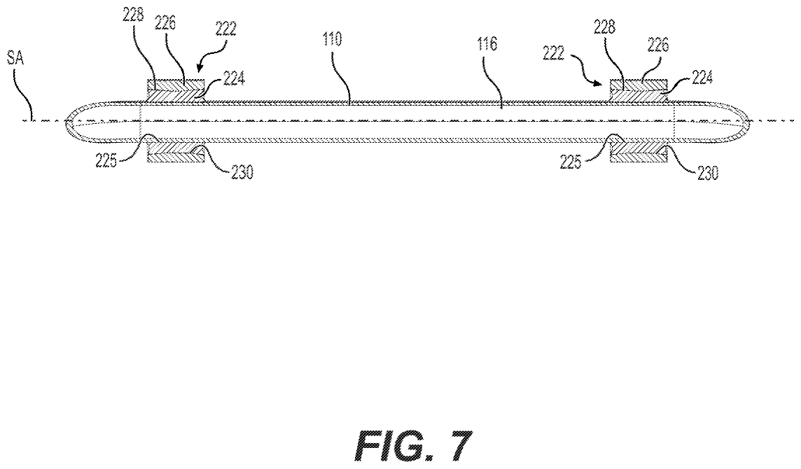

As illustrated in FIGS. 6 and 7, in an alternative embodiment, anti-roll bar connection assemblies 222 are provided instead of the anti-roll bar connection assemblies 122 described above. Each anti-roll bar connection assembly 222 includes an elastomeric insert 224 and a mounting bracket 226. The elastomeric inserts 224 and mounting brackets 226 are identical to the elastomeric inserts 124 and mounting brackets 126 described above except for the differences which will be described below.

The elastomeric insert 224 has a circular outer surface 228 which is congruous with a circular shape of the inner surface of the mounting bracket 226. Therefore, unlike the outer surface 128 of the elastomeric insert 124 described above, the outer surface 228 of the elastomeric insert 224 does not have flat sides which would prevent rotation of the outer surface 228 relative to the mounting bracket 226. Rather, the outer surface 228 of the elastomeric insert 224 is bonded to the inner side 230 of the mounting bracket 226 to prevent rotation of the outer surface 228 relative to the mounting bracket 226. More specifically, the elastomeric insert 224 is formed between the anti-roll bar 110 and the inner side 230 of the mounting bracket 226 during manufacturing of the elastomeric insert 224 (e.g., by injection molding) such that the outer surface 228 is bonded to the inner side 230 of the mounting bracket 226. The outer surface 228 is thus rotatably fixed relative to the mounting bracket 226. As such, the elastomeric insert 224 has two bonded interfaces. Notably, an inner surface 225 (FIG. 7) of the elastomeric insert 224 is bonded to the middle portion 116 of the anti-roll bar 110, and the outer surface 228 is bonded to the inner side 230 of the mounting bracket 226.

In some embodiments, the mounting bracket 226 could include multiple mounting bracket members that are affixed to one another to enclose the elastomeric insert 224 therebetween.

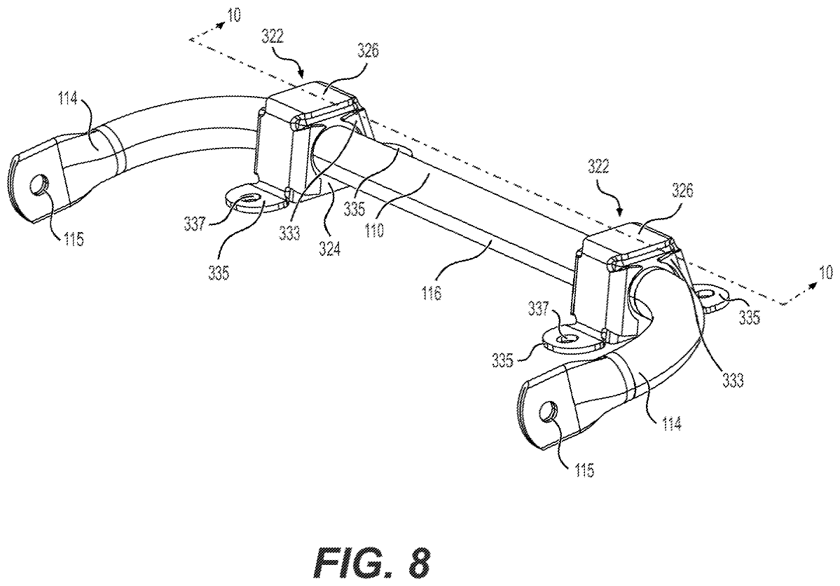

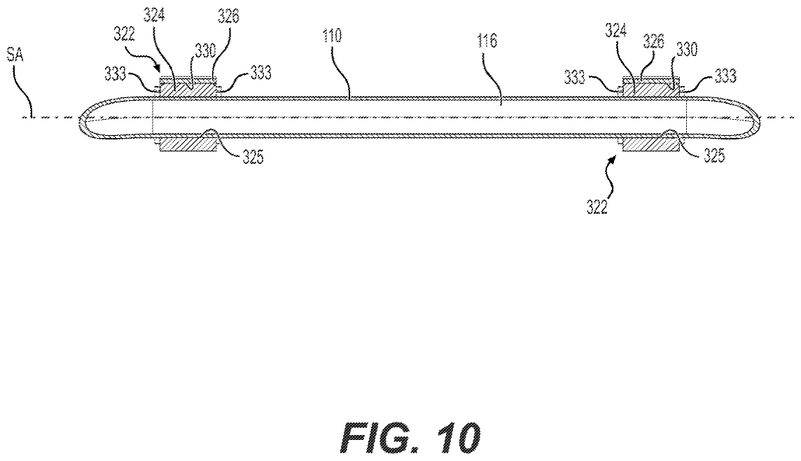

Referring now to FIGS. 8 to 10, in an alternative embodiment, anti-roll bar connection assemblies 322 are provided instead of the anti-roll bar connection assemblies 122, 222 described above. Each anti-roll bar connection assembly 322 includes an elastomeric insert 324 and a mounting bracket 324. The elastomeric inserts 324 and mounting brackets 326 are identical in configuration to the elastomeric inserts 124 and mounting brackets 126 described above except for the differences which will be described below.

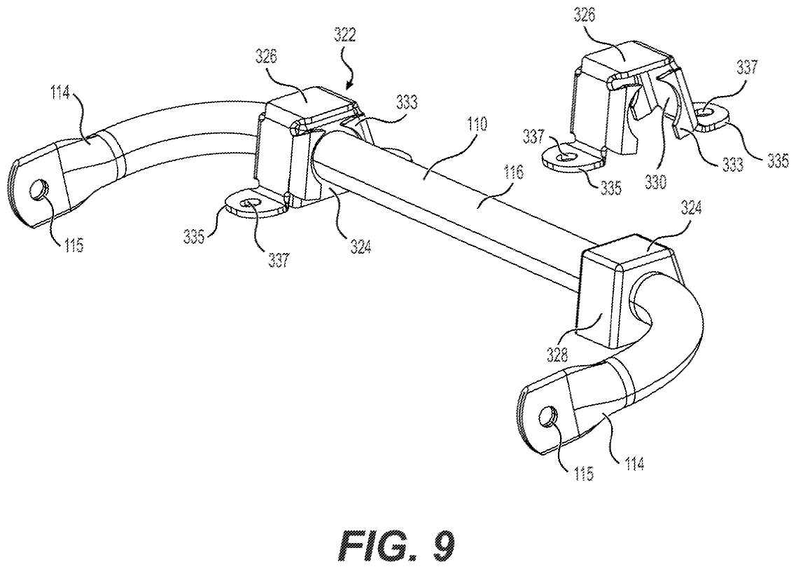

As can be seen in FIG. 9, similarly to the elastomeric insert 124, in this embodiment, an outer surface 328 of the elastomeric insert 324 has a shape that is congruous with a shape of an inner side 330 of the mounting bracket 326 to prevent rotation of the elastomeric insert 324 relative to the mounting bracket 326. Notably, the outer surface 328 of the elastomeric insert 324 has a polygonal cross-section (taken along a plane normal to the anti-roll bar axis SA). More specifically, in this embodiment, the outer surface 328 of the elastomeric insert 324 has a trapezoidal cross-section. The outer surface 328 thus has multiple flat sides that are in contact with corresponding flat surfaces of the inner side 330 of the mounting bracket 326.

The mounting bracket 326 encloses the elastomeric insert 324. In this embodiment, the mounting bracket 326 has two lateral walls 333 (one of which is shown in FIGS. 8 and 9). The mounting bracket 326 has two flanges 335, each defining a respective opening 337 for inserting a fastener therein for affixing the mounting bracket 326 to the frame 12 of the ATV 10.

In this embodiment, the mounting bracket 326 is made of bent sheet metal. It is contemplated that the mounting bracket 326 could be made otherwise in other embodiments.

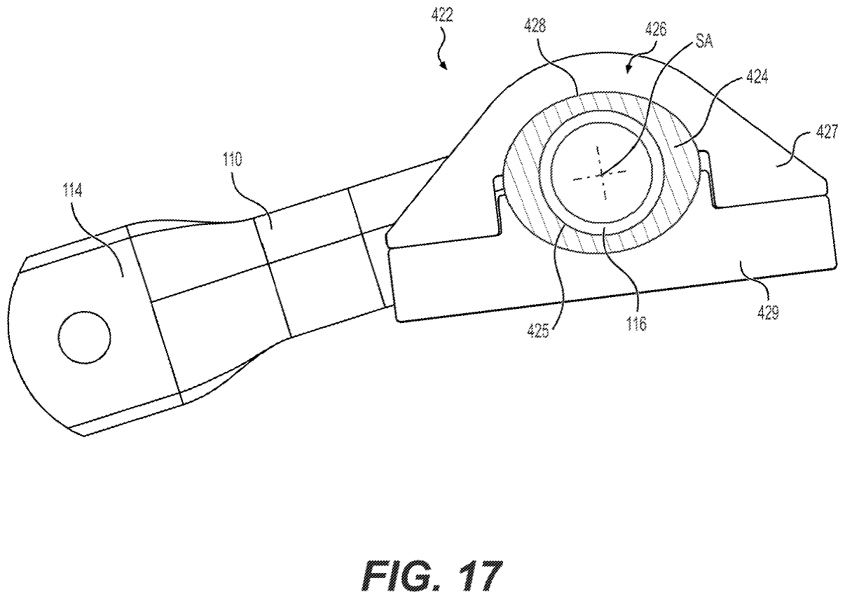

As illustrated in FIG. 17, in another alternative embodiment, anti-roll bar connection assemblies 422 (one of which is shown) are provided instead of the anti-roll bar connection assemblies 122, 222, 322 described above. Each anti-roll bar connection assembly 422 includes an elastomeric insert 424 and a mounting bracket 426. The elastomeric inserts 424 and mounting brackets 426 are identical to the elastomeric inserts 124 and mounting brackets 126 described above except for the differences which will be described below.

The elastomeric insert 424 has an oval outer surface 428 which is congruous with an oval shape of the inner surface of the mounting bracket 426. Therefore, unlike the outer surface 128 of the elastomeric insert 124 described above, the outer surface 428 of the elastomeric insert 424 does not have flat sides which would prevent rotation of the outer surface 428 relative to the mounting bracket 426. Rather, in this alternative embodiment, the oval shape of the outer surface 428 of the elastomeric insert 424 (and the congruously shaped inner side 430 of the mounting bracket 426) prevents rotation of the outer surface 428 relative to the mounting bracket 426. The outer surface 428 is thus rotatably fixed relative to the mounting bracket 426. The oval shape of the elastomeric insert 424 also increases a vertical stiffness thereof which is the most critical orientation of the stiffness of the elastomeric insert 424.

In addition, in this alternative embodiment, the mounting bracket 426 includes upper and lower bracket members 427, 429 that are affixed (e.g., bolted) to one another to enclose the elastomeric insert 424 therebetween. As such, the inner surface of the mounting bracket 426 includes an inner surface of the upper bracket member 427 and an inner surface of the lower bracket member 429.

As can be gathered from the above, the inner surfaces 125, 225, 325, 425 of the elastomeric inserts 124, 224, 324, 424 described above are fixed to the anti-roll bar 110 so that, in each embodiment, the inner surfaces 125, 225, 325, 425 rotate together with the anti-roll bar 110. As will be understood, the position at which the inner surface of any of the elastomeric inserts 124, 224, 324, 424 is fixed to the anti-roll bar 110 affects the operation of the anti-roll bar assembly 100 since the elastomeric insert 124, 224, 324, 424 will bias a corresponding end portion 114 of the anti-roll bar 110 toward that position. This position at which the inner surfaces of the elastomeric inserts 124, 224, 324, 424 are fixed to the anti-roll bar 110 will be referred to herein as a “resting position” and will be described in more detail below. While the description provided herein of the resting position is in the context of the embodiment including the elastomeric inserts 324, the same description applies to the embodiments of the elastomeric inserts 124, 224, 424 described above.

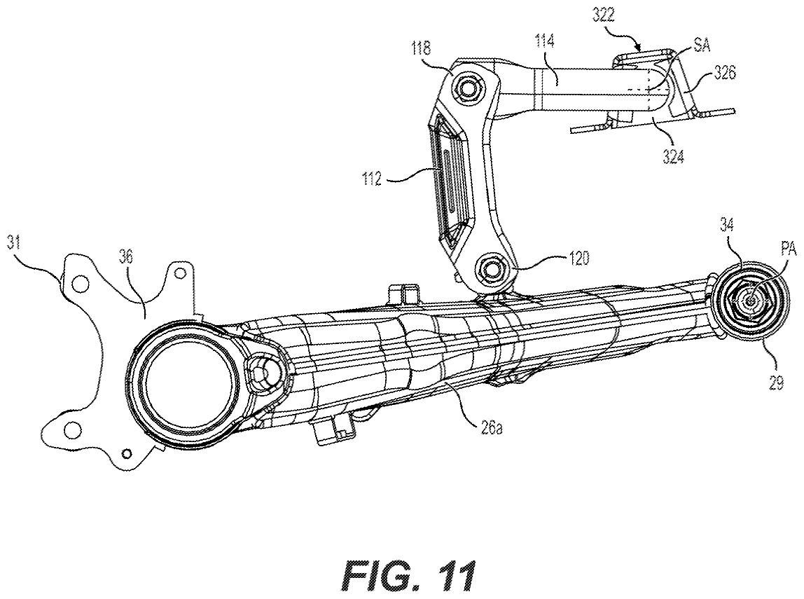

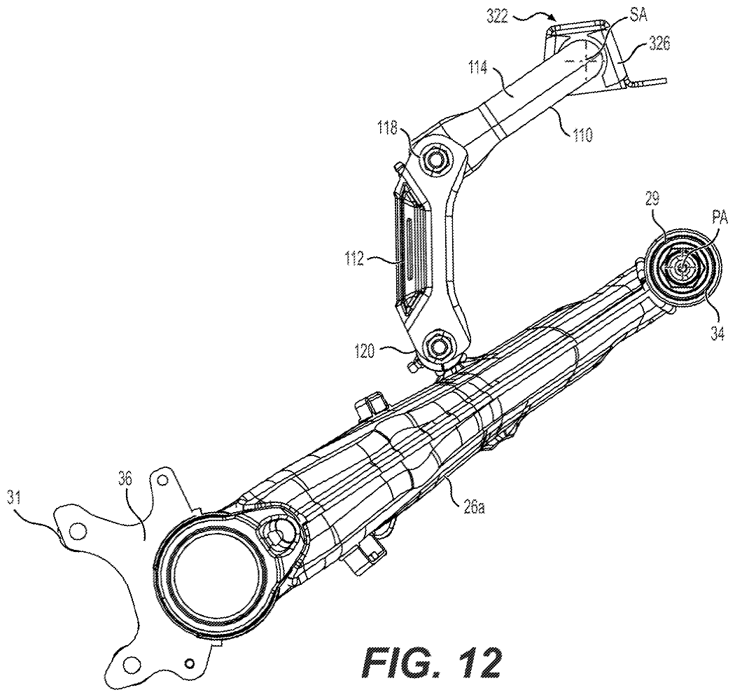

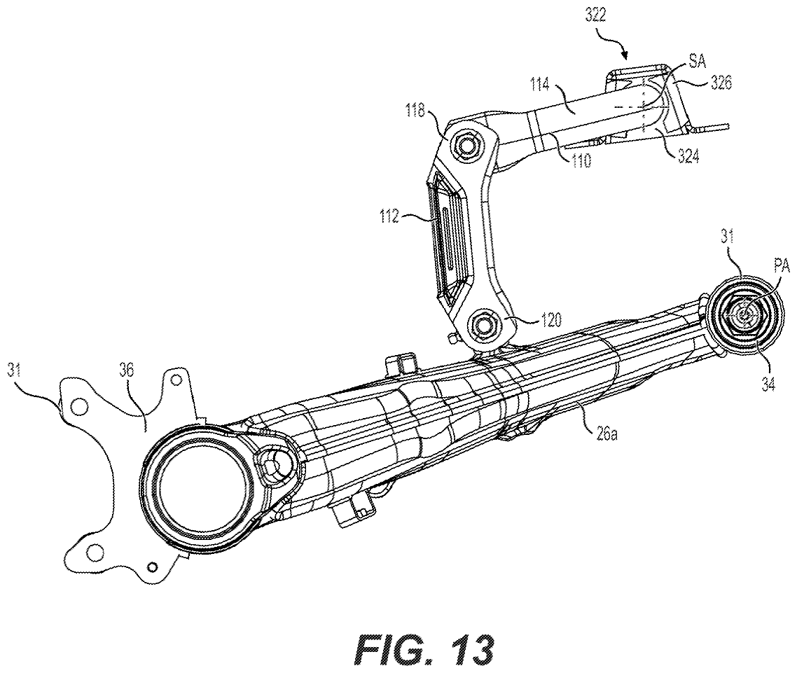

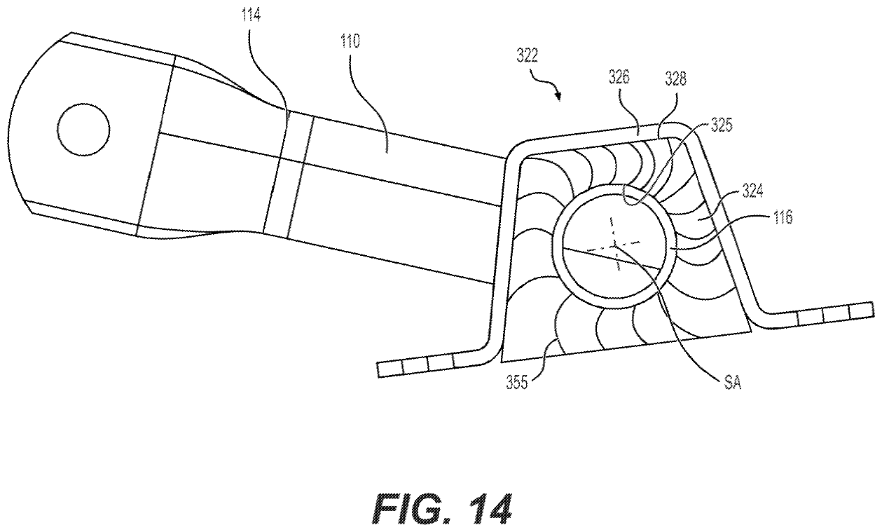

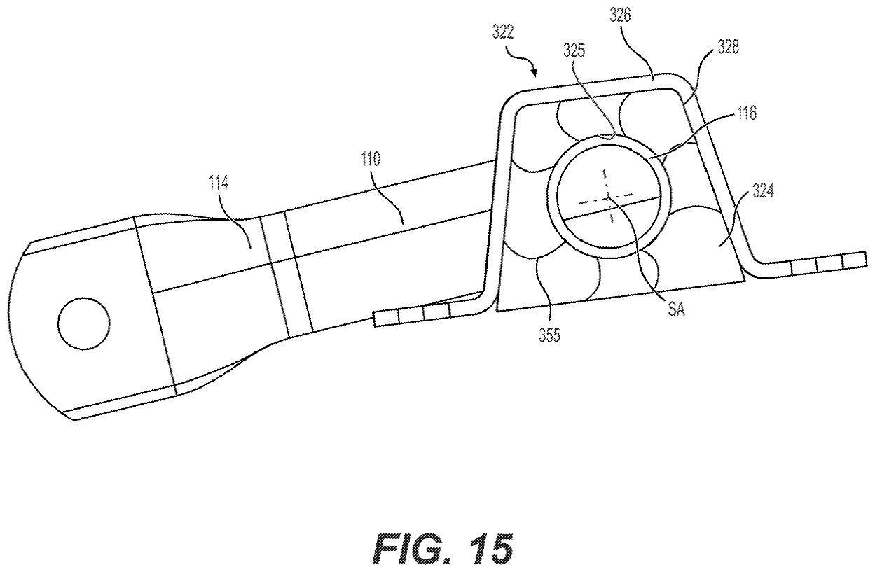

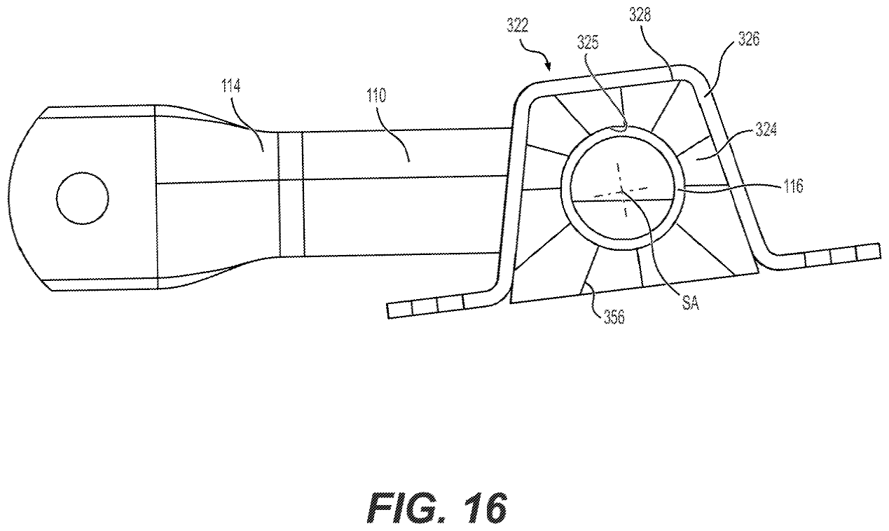

With reference to FIGS. 11 and 12, either of the suspension arms 26a can travel from a fully compressed position, shown in FIG. 11, to a fully extended position, shown in FIG. 12. The fully compressed position corresponds to the shock absorber 41 being fully compressed and the fully extended position corresponds to the shock absorber 41 being fully extended. The suspension arms 26a can also assume any other position between the fully compressed and fully extended positions. While FIGS. 11 and 12 illustrate the right suspension arm 26a, it is to be understood that the fully compressed and fully extended positions of the left suspension arm 26a are a mirror image thereof. When one of the suspension arms 26a pivots about the pivot axis PA, the associated end portion 114 of the anti-roll bar 110 pivots about the anti-roll bar axis SA since it is connected to the suspension arm 26a by a corresponding one of the links 112. For example, when the right suspension arm 26a pivots to the fully compressed position, the right end portion 114 of the anti-roll bar 110 pivots to a maximum upper position, shown in FIG. 11. Conversely, when the right suspension arm 26a pivots to the fully extended position, the right end portion 114 of the anti-roll bar 110 pivots to a maximum lower position, shown in FIG. 12. The inner surface 325 of the elastomeric insert 324 of each anti-roll bar connection assembly 322 is fixed to the anti-roll bar 110 in the resting position of the left and right end portions 114 of the anti-roll bar 110, shown for the right end portion 114 in FIG. 13 (the left end portion 114 having a resting position that is a mirror image thereof). As can be seen in FIG. 13, the resting position of both the left and right end portions 114 is defined between the maximum upper and lower positions of the left and right end portions 114. Thus, as mentioned above, the left and right end portions 114 are biased to their resting positions. Notably, as shown in FIG. 14 for the left end portion 114 of the anti-roll bar 110, in the maximum upper position of the left end portion 114, a moment is applied on the left elastomeric insert 324 as denoted by lines 355 due to the position of the inner surface 325 relative to the outer surface 328 of the elastomeric insert 324. The material of the elastomeric insert 324 is biased against the applied moment. Likewise, as shown in FIG. 15, in the maximum upper position of the left end portion 114, an opposite moment is applied on the left elastomeric insert 324 as denoted by lines 355 due to the position of the inner surface 325 relative to the outer surface 328 of the elastomeric insert 324. Again, the material of the elastomeric insert 324 is biased against the applied moment. In particular, the material of the left elastomeric insert 324 is biased toward a neutral state, shown in FIG. 16, corresponding to the resting position of the left end portion 114. Notably, as denoted by lines 356, in the neutral state of the elastomeric insert 324, no significant stress is applied on the elastomeric insert 324.

In this embodiment, the resting position of the left and right end portions 114 corresponds to a position of the anti-roll bar assembly 100 and the corresponding left and right suspension arms 26a when the ATV 10 is stationary on a flat ground surface and is unloaded (i.e., with no occupant thereon and no cargo loaded). Thus, in this embodiment, when the ATV 10 is stationary on a flat ground surface and is unloaded, the elastomeric inserts 324 of the anti-roll bar assembly 100 are in their neutral state (i.e., minimum stress applied thereto) shown in FIG. 16. Since the remaining components of the rear suspensions 26 are connected to the ATV 10 in this same state of the ATV 10, once the anti-roll bar assembly 100 is mounted to the frame 12, it can be readily connected to the suspension arms 26a without having to substantially move the anti-roll bar assembly 100 or the suspension arms 26a to align their connection points to one another. This facilitates mounting the suspension arms 26a to the anti-roll bar assembly 100 as fewer components have to be handled by the operator compared to other prior anti-roll bar assemblies.

Alternatively, the resting position of the left and right end portions 114 could be different. Notably, depending on the range of travel of the suspension arms 26a, it could be beneficial for the inner surface 325 of the elastomeric insert 324 of each anti-roll bar connection assembly 322 to be fixed to the anti-roll bar 110 in a position other than when the ATV 10 is stationary on a flat ground surface and is unloaded. For instance, in some cases, the travel of the suspension arms 26a from the fully compressed position and the fully extended position to the position thereof corresponding to when the ATV 10 is stationary on a flat ground surface and is unloaded (the “unloaded position”) may be different. For example, the travel of the suspension arms 26a between the unloaded position thereof to the fully compressed position may be greater than the travel of the suspension arms 26a between the unloaded position thereof to the fully extended position. In other words, the anti-roll bar 110 will rotate a greater amount when moving from the unloaded position to the fully compressed position of the suspension arms 26a than when moving from the unloaded position to the fully extended position of the suspension arms 26a. In such cases, the inner surface 325 of each elastomeric insert 324 could be fixed to the anti-roll bar 110 such that the elastomeric insert 324 is preloaded in the unloaded position of the suspension arms 26a so as to more equally distribute the stress applied on the elastomeric insert 324 over the range of travel of the suspension arms 26a. More specifically, the inner surface 325 of each elastomeric insert 324 is fixed to the anti-roll bar 110 such that a More specifically, the inner surface 325 of each elastomeric insert 324 is fixed to the anti-roll bar 110 such that, when the suspension arms 26a travel from the unloaded position to the fully compressed position, a stress in a first direction (e.g., a clockwise direction) is applied on the elastomeric inserts 324 over a first portion of the motion of the suspension arms 26a until the suspension arms 26a reach a position corresponding to the neutral state of the elastomeric inserts 324, and a stress in a second direction (e.g., a counterclockwise direction) is applied on the elastomeric inserts 324 over a second portion of the motion of the suspension arms 26a. This may avoid overloading the elastomeric inserts 324 when the suspension arms 26a travel from the unloaded position to the fully compressed position (as shown in FIG. 14). Of course, the opposite could be applicable if the travel of the suspension arms 26a is greater between the unloaded position and the fully extended position than between the unloaded position and the fully compressed position.

While in the above-described embodiments, the anti-roll bar assembly 100 has been described as being connected to the suspension arms 26a of the rear suspension assemblies 26, it is contemplated that, in alternative embodiments, the anti-roll bar assembly 100 could be operatively interconnect the suspension arms of two front suspension assemblies.

Furthermore, while the present technology has been described in respect of the ATV 10, it is contemplated that the anti-roll bar assembly 100 could also be integrated in different types of vehicles in other embodiments.

Modifications and improvements to the above-described embodiments of the present technology may become apparent to those skilled in the art. The foregoing description is intended to be exemplary rather than limiting. The scope of the present technology is therefore intended to be limited solely by the scope of the appended claims.

What is claimed is:

1. A vehicle comprising:
a frame;
a seat supported by the frame;
a motor supported by the frame;
a plurality of ground-engaging members operatively connected to the frame, at least one ground-engaging member of the plurality of ground-engaging members being operatively connected to the motor for propelling the vehicle, the plurality of ground-engaging members including:
a left ground-engaging member disposed on a left side of a longitudinal centerplane of the vehicle; and
a right ground-engaging member disposed on a right side of the longitudinal centerplane of the vehicle;
a left suspension arm operatively connecting the left ground-engaging member to the frame;
a right suspension arm operatively connecting the right ground-engaging member to the frame; and
an anti-roll bar assembly operatively connecting the left suspension arm to the right suspension arm, the anti-roll bar assembly comprising:
an anti-roll bar having a left end portion, a right end portion and a middle portion extending between the left and right end portions,
the left end portion being operatively connected to the left suspension arm,
the right end portion being operatively connected to the right suspension arm; and
at least one anti-roll bar connection assembly connecting the middle portion of the anti-roll bar to the frame, each of the at least one anti-roll bar connection assembly comprising:
an elastomeric insert mounted to the anti-roll bar, the elastomeric insert engaging the anti-roll bar such that an inner surface of the elastomeric insert rotates together with the anti-roll bar; and
a mounting bracket connected to the frame and at least partly enclosing the elastomeric insert, an outer surface of the elastomeric insert being rotatably fixed relative to the mounting bracket.

2. The vehicle of claim 1, wherein the outer surface of the elastomeric insert has a shape that is congruous with a shape of an inner side of the mounting bracket to prevent rotation of the elastomeric insert relative to the mounting bracket.

3. The vehicle of claim 2, wherein the outer surface of the elastomeric insert has at least one flat side.

4. The vehicle of claim 1, wherein the elastomeric insert is bonded to the mounting bracket to prevent rotation of the outer surface of the elastomeric insert relative to the mounting bracket.

5. The vehicle of claim 1, wherein:
the left and right end portions of the anti-roll bar are rotatable about an anti-roll bar axis extending generally laterally between a maximum upper position and a maximum lower position; and
the inner surface of the elastomeric insert is fixed to the anti-roll bar in a resting position of the left and right end portions defined between the maximum upper position and the maximum lower position so that the left and right end portions of the anti-roll bar are biased toward the resting position.

6. The vehicle of claim 5, wherein the resting position of the left and right end portions of the anti-roll bar corresponds to a position of the anti-roll bar assembly and the left and right suspension arms when the vehicle is stationary on a flat ground surface.

7. The vehicle of claim 1, wherein the inner surface of the elastomeric insert is bonded to the anti-roll bar.

8. The vehicle of claim 1, wherein the at least one anti-roll bar connection assembly includes a first anti-roll bar connection assembly and a second anti-roll bar connection assembly.

9. The vehicle of claim 7, wherein the elastomeric insert is formed on the anti-roll bar so that the inner surface of the elastomeric insert is bonded to the anti-roll bar.

10. The vehicle of claim 1, wherein the anti-roll bar assembly further comprises:
a left link operatively connected between the left end portion of the anti-roll bar and the left suspension arm; and
a right link operatively connected between the right end portion of the anti-roll bar and the right suspension arm.

11. The vehicle of claim 1, wherein the vehicle is an all-terrain vehicle (ATV).

12. An anti-roll bar assembly for a vehicle, comprising:
an anti-roll bar having a left end portion, a right end portion and a middle portion extending between the left and right end portions,
the left end portion being configured to be operatively connected to a left suspension arm of the vehicle,
the right end portion being configured to be operatively connected to a right suspension arm of the vehicle; and
at least one anti-roll bar connection assembly configured to connect the middle portion of the anti-roll bar to a frame of the vehicle, each of the at least one anti-roll bar connection assembly comprising:
an elastomeric insert mounted to the anti-roll bar, the elastomeric insert engaging the anti-roll bar such that an inner surface of the elastomeric insert rotates together with the anti-roll bar; and
a mounting bracket configured to be connected to the frame of the vehicle and at least partly enclosing the elastomeric insert, an outer surface of the elastomeric insert being rotatably fixed relative to the mounting bracket.

13. The anti-roll bar assembly of claim 12, wherein the outer surface of the elastomeric insert has a shape that is congruous with a shape of an inner side of the mounting bracket to prevent rotation of the elastomeric insert relative to the mounting bracket.

14. The anti-roll bar assembly of claim 13, wherein the outer surface of the elastomeric insert has at least one flat side.

15. The anti-roll bar assembly of claim 12, wherein the elastomeric insert is bonded to the mounting bracket to prevent rotation of the outer surface of the elastomeric insert relative to the mounting bracket.

16. The anti-roll bar assembly of claim 12, wherein the elastomeric insert is made of rubber.

17. The anti-roll bar assembly of claim 12, wherein the at least one anti-roll bar connection assembly includes a first anti-roll bar connection assembly and a second anti-roll bar connection assembly.

18. The anti-roll bar assembly of claim 12, wherein the inner surface of the elastomeric insert is bonded to the anti-roll bar.

19. The anti-roll bar assembly of claim 18, wherein the elastomeric insert is formed on the anti-roll bar so that the inner surface of the elastomeric insert is bonded to the anti-roll bar.

20. The anti-roll bar assembly of claim 12, further comprising:
a left link operatively connected to the left end portion of the anti-roll bar and configured to be operatively connected to the left suspension arm; and
a right link operatively connected to the right end portion of the anti-roll bar and configured to be operatively connected to the right suspension arm.
